(19) United States
(12) Patent Application Publication
(10) Pub. No.: US 2007/0242846 A1
(43) Pub. Date: Oct. 18, 2007

(54) Outdoor decorative audio output system

(76) Inventors: Feng Li, Hacienda Ht., CA (US); Dennis Hsien Ming Cheng, Carson, CA (US)

Correspondence Address: Raymond Y. Chan, Suite 128, 108 N. Ynez Avenue, Monterey Park, CA, 91754, US

(21) Appl. No.: 11/404,917

(22) Filed: Apr. 13, 2006

(51) Int. Cl. H04R 1/02; H04R 9/06

(52) U.S. Cl. 381/334; 381/124

(57) ABSTRACT

An outdoor decorative audio output system includes an outdoor decorative housing and an audio system. The outdoor decorative housing, which is shaped to have an aesthetically natural appeal with weather resistant ability, has an audio cavity, an audio outlet communicating with the audio cavity, and a player compartment for receiving a portable audio player therein. The audio system, which is electrically connected with a power source, includes an audio output receiving in the audio cavity and an audio signal input which is electrically connected to the audio output and is provided at the decorative housing for communicatively connecting the portable audio player, wherein the audio signal input is adapted for receiving an audio signal from the audio player, such that the audio output converts the audio signal into an audible signal to create an optimal environmental audio effect for outdoors.

### BACKGROUND OF THE PRESENT INVENTION

1. Field of Invention

The present invention relates to an audio system, and more particularly to an outdoor decorative audio output system which is capable of generating an optimal environment audio effect in outdoor environment.

2. Description of Related Arts

A conventional audio system usually comprises a main audio unit, and at least one audio speaker spacedly positioned apart from the main audio unit, and is electrically connected therewith in such a manner that the main audio unit is adapted to play a predetermined audio medium and transmit the corresponding sound signal to the audio speaker for delivering sound from the audio speaker to an exterior thereof. The conventional audio system may further comprise a remote control and a sound enhancement system built in the audio speaker for enhancing the quality of the sound outputted therefrom.

A major disadvantage of this conventional audio system is that it is not suitable for outdoor use. For example, when a user wishes to play particular sound tracks in an outdoor environment by the conventional audio system, that user has two basic options. First, he or she may actually carry the entire audio system to the location in which the sound is to be delivered. In this scenario, the user has to figure out how to connect the audio system with a power source in that outdoor environment. The problem with this option is that it is extremely inconvenient for the user to carry the entire audio system each time it is to be used in the outdoor environment. Moreover, the appearance of the audio system may not fully incompatible with the outdoor environment so that it may affect the activity taking place in that environment.

Second, the user may wish to place only the audio speaker to the outdoor environment leave the main audio unit in an indoor environment. In such a scenario, the user need an electric wire having an extended length for electrically connecting the main audio unit with the audio speaker so that the user may control the playing of the audio media in the indoor environment. The problem here is that the location at which the audio speaker can be placed is very limited since one simply cannot infinitely extend the length of the wires connecting the main audio unit and the audio speaker. Moreover, the wires and the audio speaker may be vulnerable to environmental factors in such outdoor environment.

### SUMMARY OF THE PRESENT INVENTION

A main object of the present invention is to provide an outdoor decorative audio output system which is capable of generating an optimal environment audio effect in outdoor environment.

Another object of the present invention is to provide an outdoor decorative audio output system comprising an outdoor decorative housing and an audio system received in the outdoor decorative housing, wherein the audio system is adapted to deliver optimal environmental audio effect in a weatherproof environment (i.e. within the outdoor decorative housing). In other words, the present invention is optimal for use in an outdoor environment.

Another object of the present invention is to provide an outdoor decorative audio output system comprising an outdoor decorative housing, which is shaped and sized to have an atheistically appealing appearance so as to optimally compatible with ambient environment.

Another object of the present invention is to provide an outdoor decorative audio output system which is capable of playing a wide variety of audio media (e.g. CDs, radio broadcast etc.) so as to provide the user of the present invention with plenty of audio selections corresponding to each audio media.

Another object of the present invention is to provide an outdoor decorative audio output system which is easy to install in outdoor environment.

Another object of the present invention is to provide an outdoor decorative audio output system which does not involve any complicated or expensive components so as to minimize the manufacturing cost of the present invention.

Accordingly, in order to accomplish the above objects, the present invention provides an outdoor decorative audio output system, comprising:

an outdoor decorative housing, which is shaped to have an aesthetically natural appeal with weather resistant ability, having an audio cavity, an audio outlet communicating with the audio cavity, and a player compartment for receiving a portable audio player therein; and

an audio system, which is electrically connected with a power source, comprising an audio output receiving in the audio cavity and an audio signal input which is electrically connected to the audio output and is provided at the decorative housing for communicatively connecting the portable audio player, wherein the audio signal input is adapted for receiving an audio signal from the audio player, such that the audio output converts the audio signal into an audible signal and delivers the audible signal to an exterior of the decorative housing through the audio outlet so as to create an optimal environmental audio effect for outdoors.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of an outdoor decorative audio system according to a preferred embodiment of the present invention.

FIG. 2 is a sectional side view of the outdoor decorative audio system according to the above preferred embodiment of the present invention.

FIG. 3 is an alternative mode of the outdoor decorative audio system according to the above preferred embodiment of the present invention.

FIG. 4 is a sectional side view of the alternative mode of the outdoor decorative audio system according to the above preferred embodiment of the present invention.

### DETAILED DESCRIPTION OF THE PREFERRED EMBODIMENT

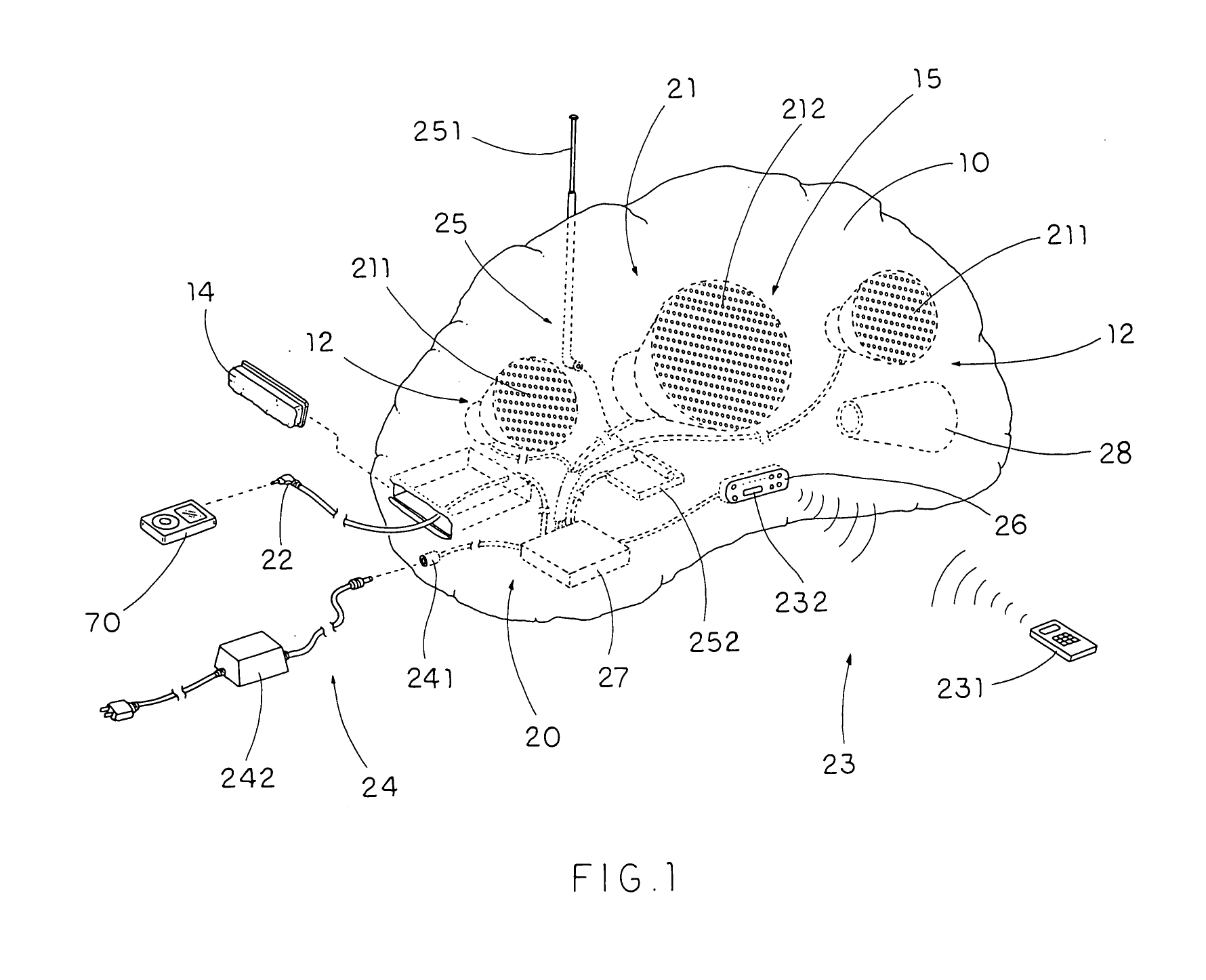

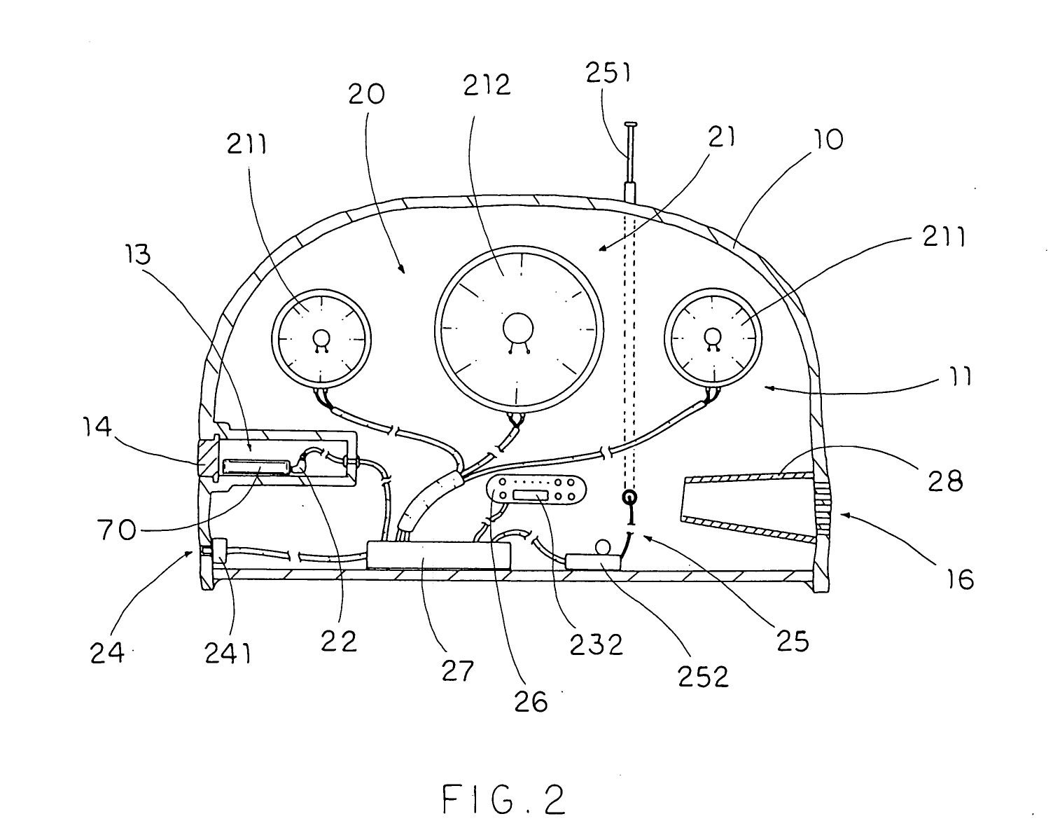

Referring to FIG. 1 to FIG. 2 of the drawings, an outdoor decorative audio output system according to a preferred embodiment of the present invention is illustrated, in which the outdoor decorative audio output system comprises an outdoor decorative housing 10, and an audio system 20.

The outdoor decorative housing 10, which is shaped to have an aesthetically natural appeal with weather resistant ability, having an audio cavity 11, at least one audio outlet 12 communicating with said audio cavity 11, and a player compartment 13 for receiving a portable audio player 70 therein.

The audio system 20, which is electrically connected with a power source, comprising at least one audio output 21 receiving in the audio cavity 11 and an audio signal input 22 which is electrically connected to the audio output 21 and is provided at the decorative housing 10 for communicatively connecting the portable audio player 70, wherein the audio signal input 22 is adapted for receiving an audio signal from the audio player 70, such that the audio output 21 converts the audio signal into an audible signal and delivers the audible signal to an exterior of the decorative housing 10 through the audio outlet 12 so as to create an optimal environmental audio effect for outdoor.

According to the preferred embodiment of the present invention, the outdoor decorative housing 10 is preferably shaped and sized to have an aesthetically sound appearance of a particular fixture which is compatible with the ambient environment in which the present invention is located. As shown in FIG. 1 of the drawings, the outdoor decorative housing 10 is embodied as having an appearance of an artificial rock having a corresponding natural stone color for emulating natural rocks, wherein the outdoor decorative housing 10 has a flat bottom surface and an irregular outer rock-like surface, and is made of glass-reinforced resin to create sturdy enclosures with low acoustic resonance for an ultimate sound experience. As a result, the outdoor decorative housing 10 is optimal for aesthetically merging with the ambient environment while adapted for delivering high quality sound.

On the other hand, the audio cavity 11 and the player compartment 13 of the outdoor decorative housing 10 are two individual cavities formed in a concealed manner such that the audio system 20 is sealedly enclosed within the audio cavity 11 for restricting an unwanted access to the audio system 20.

The audio system 20 further comprises a remote control unit 23 comprising a remote controller 231 and a remote sensor 232 provided on the outdoor decorative housing 10 to electrically communicate with the audio output 21 for remotely controlling an operation thereof. In other words, the audio output 21 can be controlled through the remote controller 231 and the remote sensor 232.

The audio output 21 comprises two speakers 211 which are capable of delivering audible sound with a predetermined intensity. Preferably, the speaker has a substantially circular cross section and a diameter of approximately 8 inches. In order to enhance the quality of the environmental audio effect of the present invention, the audio output 21 further comprises a subwoofer unit 212 electrically communicated with the speakers 211 for creating very low bass frequencies. In other words, the audio system 20 is capable of producing a wide range of audio sound effect to accomplish the optimal environmental audio effect. Accordingly, the outdoor decorative housing 10 further has a subwoofer opening 15 formed thereon for communicating with the subwoofer unit 212 for delivering bass of predetermined intensity.

Moreover, the audio system 20 further comprises an audio circuitry 27 received in the outdoor decorative housing 10 and electrically connect to the audio output 21 for converting and amplifying the audio signal coming out from the user's portable audio player 70 to the audible sound signal of the optimal environmental audio effect.

The outdoor decorative housing 10 further comprises an enclosure cover 14 movably attached thereon to move between an enclosing position and an operation position, wherein in the operation position, the enclosure cover 14 is moved to expose the audio outlet 12 of the outdoor decorative housing 10 for allowing the audio signal input 22 to be connected with the portable audio player 70, wherein in the enclosing position, the enclosure cover 14 is moved to enclose the audio outlet 12 so as to retain the aesthetically appealing appearance for maximally matching with the ambient environment.

The audio system 20 further comprises a power input system 24 comprising a waterproof power inlet 241 sealedly provided on the outdoor decorative housing 10 to electrically connect with the audio output 21 for providing power thereto, wherein the power inlet 241 is adapted for connecting to an external power source for acquiring electrical energy to operate the audio output 21. The power input system 24 further comprises a waterproof transformer 242 adapted for detachably connecting between the power inlet 241 and the external power source for converting an external power voltage to a voltage which is suitable for being fed to the audio output 21 in a safe manner.

It is worth mentioning that the present invention is meant to provide a wide range of audio options to the user. As such, the audio system 20 further comprises a radio unit 25 comprising a telescopic antenna 251 removably affixed on the outdoors decorative housing 10 in a slidably extendable manner for receiving a radio signal from an external broadcasting station, and a radio module 252 electrically connecting between the telescopic antenna 251 and the audio output 21 for producing a corresponding audible signal in accordance with the radio signal received by the telescopic antenna 251.

The audio system 20 further comprises a control panel 26 provided on the outdoor decorative housing 10 to electrically connect with the audio output 21 and the radio unit 25, wherein the control panel 26 is adapted for being switched to control an operation and display the corresponding operational parameters of the audio output 21 and the radio unit 25. In other words, the user of the present invention is able to control and monitor the operation of the audio system 20 via the control panel 26. For example, the user is able to freely adjust the volume or bass intensity of the sound outputted from the audio output 21 by pressing or switching on the control panel 26. Moreover, the control panel 26 is adapted for tuning radio channels as received by the telescopic antenna 251 so as allow the user to selectively pick his or her favorite radio channel.

The operation of the present invention is as follows: the outdoor decorative audio output system is meant to be utilized for producing the environmental audio effect in outdoor environment. The user should first prepare a portable audio player 70, such as a portable CD player, and carry the outdoor decorative audio output system to a desirable location. After that the user should connect the portable audio player 70 to the audio system 20 via the audio signal input 22. The user may then turn on the audio output 21 by the remote control unit 23 or the control panel 26. The audio system 20 will then produce the corresponding audible sound as played by the user's portable audio player 70. It is worth mentioning that the user's portable audio player 70 is adapted to be put in the player compartment 13 so as to protect it from being interfered by adverse environmental factors. It is also important to point out that the user's portable audio player can also be embodied as other audio players such as a MP3 player or an iPod player.

It is particularly important to point out that the outdoor decorative housing 10 resembles much of environmental objects, such as rocks, so that when it is not in use, the user may simply leave it in outdoor environments for decoration. When it is in use, however, the audible sound effect is arranged to be optimally compatible to ambient environment.

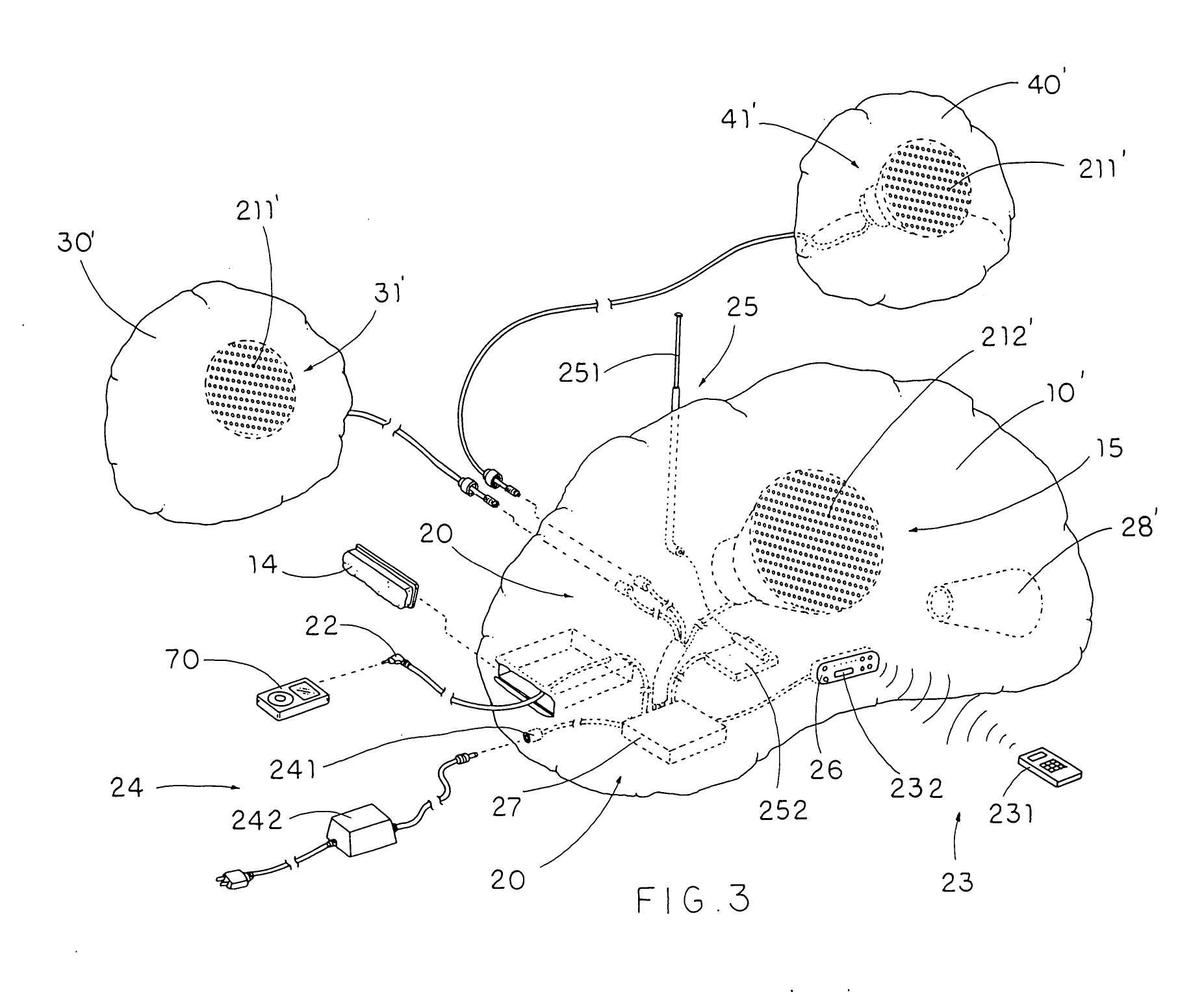

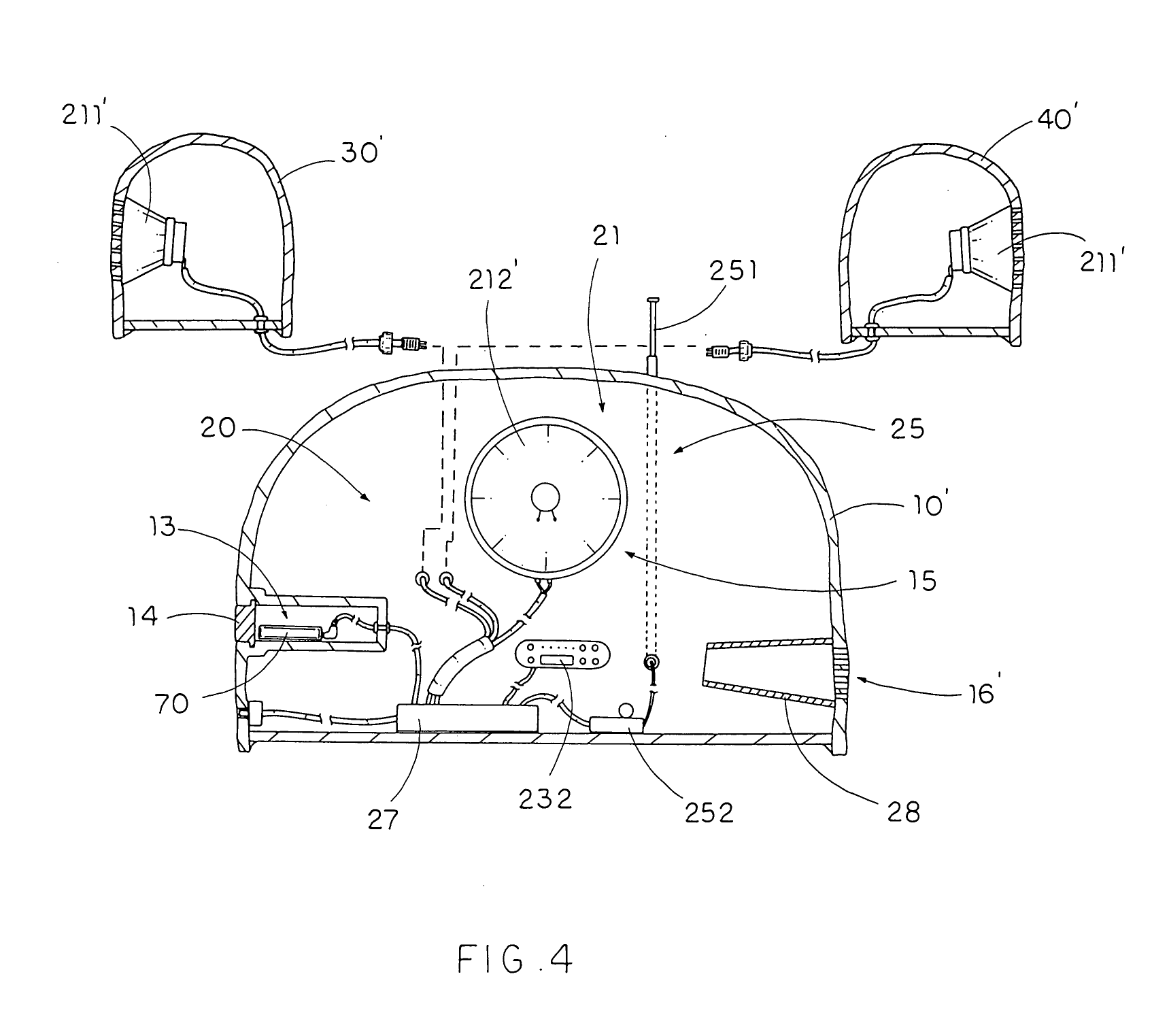

Referring to FIG. 3 to FIG. 4 of the drawings, the outdoor decorative audio output system according to an alternative mode of the present invention is illustrated. The alternative mode is similar to the preferred embodiment except that the outdoor decorative audio output system further comprises two auxiliary decorative housing 30′, 40′ each of which is substantially resembled to the decorative housing 10′, wherein the two speakers 211′ are mounted within the two auxiliary decorative housings 30′, 40′ for delivering the audible sound, while the subwoofer unit 212′ is mounted in the decorative housing 10′. Accordingly, the audio outlets 31′, 41′ are formed on the two auxiliary decorative housings 30′, 40′ respectively.

Consequently, the audio signal from the portable audio player 70 is received by the decorative housing 10′ which then electrically transmit, preferably via waterproof audio sockets, waterproof plug and waterproof electric wires, the audio signal to the speakers 211′ of the auxiliary decorative housing 30′, 40′ for delivering the audible sound. As a result, the decorative housing 10′ and the auxiliary decorative housing 30′, 40′ are adapted to form a speaker system for use in outdoor environment.

Referring to FIG. 1 to FIG. 4 of the drawings, the audio system 20 further comprises a resonant cone 28 (28′) and is aligned with a resonant opening 16 (16′) formed on the decorative housing 10 (10′) provided in the decorative housing 10 (10′) for enhancing the sound quality delivered by the audio system 20.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An outdoor decorative audio output system, comprising:
an outdoor decorative housing, which is shaped to have an aesthetically natural appeal with weather resistant ability, having an audio cavity, an audio outlet communicating with said audio cavity, and a player compartment for receiving a portable audio player therein; and
an audio system, which is electrically connected with a power source, comprising an audio output receiving in said audio cavity and an audio signal input which is electrically connected to said audio output and is provided at said decorative housing for communicatively connecting said portable audio player, wherein said audio signal input is adapted for receiving an audio signal from said audio player, such that said audio output converts said audio signal into an audible signal and delivers said audible signal to an exterior of said decorative housing through said audio outlet so as to create an optimal environmental audio effect for outdoors.

2. The outdoor decorative audio output system, as recited in claim 1, wherein said outdoor decorative housing, having an appearance of an artificial rock having a natural stone color to emulate natural rocks, has a flat bottom surface and an irregular outer rock-like surface, wherein said outer decorative housing is made of glass-reinforced resin to create sturdy enclosures with low acoustic resonance for an ultimate sound experience.

3. The outdoor decorative audio output system, as recited in claim 1, wherein said audio cavity and said player compartment of said outdoor decorative housing are two individual cavities in a concealed manner such that said audio system is sealedly enclosed within said audio cavity for restricting an unwanted access to said audio system.

4. The outdoor decorative audio output system, as recited in claim 2, wherein said audio cavity and said player compartment of said outdoor decorative housing are two individual cavities in a concealed manner such that said audio system is sealedly enclosed within said audio cavity for restricting an unwanted access to said audio system.

5. The outdoor decorative audio output system, as recited in claim 1, wherein said outdoor decorative housing further comprises an enclosure cover detachably attached thereon to enclose said player compartment for concealing said portable audio player therein in a waterproof manner, wherein said enclosure cover is shaped to match with said outdoor decorative housing to retain an aesthetically appealing appearance of said outdoor decorative housing for maximally matching with ambient environment.

6. The outdoor decorative audio output system, as recited in claim 2, wherein said outdoor decorative housing further comprises an enclosure cover detachably attached thereon to enclose said player compartment for concealing said portable audio player therein in a waterproof manner, wherein said enclosure cover is shaped to match with said outdoor decorative housing to retain an aesthetically appealing appearance of said outdoor decorative housing for maximally matching with ambient environment.

7. The outdoor decorative audio output system, as recited in claim 4, wherein said outdoor decorative housing further comprises an enclosure cover detachably attached thereon to enclose said player compartment for concealing said portable audio player therein in a waterproof manner, wherein said enclosure cover is shaped to match with said outdoor decorative housing to retain an aesthetically appealing appearance of said outdoor decorative housing for maximally matching with ambient environment.

8. The outdoor decorative audio output system, as recited in claim 1, wherein said audio system further comprises a power input system comprising a waterproof power inlet which is sealedly provided on said outdoor decorative housing and is electrically connect with said audio output, and a waterproof transformer detachably connecting to said waterproof power inlet for electrically connecting said audio output with said power source in a safety manner.

9. The outdoor decorative audio output system, as recited in claim 4, wherein said audio system further comprises a power input system comprising a waterproof power inlet which is sealedly provided on said outdoor decorative housing and is electrically connect with said audio output, and a waterproof transformer detachably connecting to said waterproof power inlet for electrically connecting said audio output with said power source in a safety manner.

10. The outdoor decorative audio output system, as recited in claim 7, wherein said audio system further comprises a power input system comprising a waterproof power inlet which is sealedly provided on said outdoor decorative housing and is electrically connect with said audio output, and a waterproof transformer detachably connecting to said waterproof power inlet for electrically connecting said audio output with said power source in a safety manner.

11. The outdoor decorative audio output system, as recited in claim 9, wherein said audio system further comprises a radio unit comprising a telescopic antenna removably affixed on said outdoors decorative housing in a slidably extendable manner for receiving a radio signal from an external broadcasting station, and a radio module electrically connecting between said telescopic antenna and said audio output for producing said audio signal in accordance with said radio signal received by said telescopic antenna.

12. The outdoor decorative audio output system, as recited in claim 10, wherein said audio system further comprises a radio unit comprising a telescopic antenna removably affixed on said outdoors decorative housing in a slidably extendable manner for receiving a radio signal from an external broadcasting station, and a radio module electrically connecting between said telescopic antenna and said audio output for producing said audio signal in accordance with said radio signal received by said telescopic antenna.

13. The outdoor decorative audio output system, as recited in claim 11, wherein said audio system further comprises a remote control unit comprising a remote sensor provided on said outdoor decorative housing to electrically communicate with said audio system and a remote controller wirelessly communicating with said remote sensor to remotely control an operation of said audio system.

14. The outdoor decorative audio output system, as recited in claim 12, wherein said audio system further comprises a remote control unit comprising a remote sensor provided on said outdoor decorative housing to electrically communicate with said audio system and a remote controller wirelessly communicating with said remote sensor to remotely control an operation of said audio system.

15. The outdoor decorative audio output system, as recited in claim 13, wherein said audio system further comprises a control panel sealedly provided on said outdoor decorative housing to electrically connect with said audio output for displaying an operational parameter of said audio system.

16. The outdoor decorative audio output system, as recited in claim 14, wherein said audio system further comprises a control panel sealedly provided on said outdoor decorative housing to electrically connect with said audio output for displaying an operational parameter of said audio system.

17. The outdoor decorative audio output system, as recited in claim 15, wherein said audio output comprises a speaker securely supported in said audio cavity at a position aligned with said audio outlet so as to deliver said audible sound with a predetermined intensity through said audio outlet.

18. The outdoor decorative audio output system, as recited in claim 16, wherein said audio output comprises a speaker securely supported in said audio cavity at a position aligned with said audio outlet so as to deliver said audible sound with a predetermined intensity through said audio outlet.

19. The outdoor decorative audio output system, as recited in claim 15, wherein said audio output comprises a subwoofer unit securely supported in said audio cavity at a position aligned with said audio outlet for enhancing said audio sound through said audio outlet.

20. The outdoor decorative audio output system, as recited in claim 16, wherein said audio output comprises a subwoofer unit securely supported in said audio cavity at a position aligned with said audio outlet for enhancing said audio sound through said audio outlet.
